(19) United States
(12) Patent Application Publication
(10) Pub. No.: US 2003/0037476 A1
(43) Pub. Date: Feb. 27, 2003

(54) Method and dispenser for attracting wild animals

(76) Inventor: Michael R. Peavy, Choctaw, OK (US)

Correspondence Address: DUNLAP, CODDING & ROGERS P.C., PO BOX 16370, OKLAHOMA CITY, OK, 73114, US

(21) Appl. No.: 09/940,194

(22) Filed: Aug. 27, 2001

(51) Int. Cl. A01M 1/00

(52) U.S. Cl. 43/1

(57) ABSTRACT

A method and dispenser for attracting wild animals utilizing readily, commercially available hand warmer pads and commercially available wild animal scent sources, both of which are familiar to most wild game hunters. These products are used in a pouch formed of a material through which the scent may penetrate to provide the final dispenser.

### RELATED REFERENCES

Not applicable.

### BACKGROUND OF THE INVENTION

This invention relates to a method and dispenser for attracting or luring wild animals using readily available, commercial components.

Hunters looking for many different types of wild animals, such as deer and elk, have used a wide variety of scents which are believed to be attractive to the particular wild animal species being hunted. Such scents are readily available from many commercial sources and which can be in almost any form, but are normally in a liquid, paste or gel form. The scent producing composition may be applied at any particular location, such as on the clothing of the hunter or on a tree or the like where it is believed the species being sought will encounter.

It is also known that the scent given off by a scent producing composition will be more readily dispensed if the composition is heated. Heretofore, however, the heat source which has been provided for heating the scent producing composition has been a complicated, expensive product, and none have been placed in wide spread use.

### SUMMARY OF THE INVENTION

The present invention makes use of readily, commercially available hand warmers which are activated either by squeezing a pad containing the reactants by repeatedly squeezing the pad or by shaking the pad for a few minutes, depending upon the particular reactants contained in the pad. The present invention also makes use of readily available compositions which produce the scent desired for the species of animal being hunted. These products are combined with any simple pouch formed of a material through which the scent vapors may penetrate.

### BRIEF DESCRIPTION OF THE DRAWINGS

FIG. 1 is an elevational view of a dispenser of the present invention mounted on a tree limb, illustrating one use of the dispenser.

FIG. 2 is a perspective view of a pad of a commercially available hand warmer and illustrating the application of a scent source onto that pad.

FIG. 3 is a side view of a pouch containing the pad of FIG. 2 to provide the final dispenser.

### DETAILED DESCRIPTION

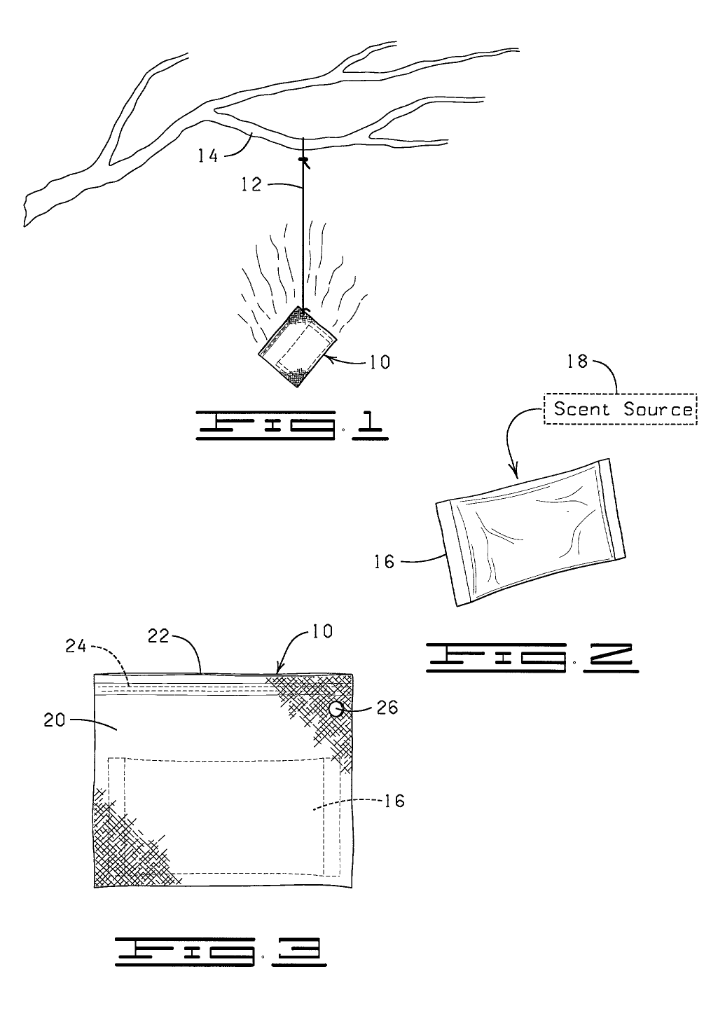

Referring to the drawings in detail, and particularly FIG. 1, reference character 10 generally designates a dispenser of the present invention shown being hung by a cord or rope 12 from a tree limb 14, thus illustrating a common use of the dispenser of this invention.

The dispenser 10 makes use of a conventional hand warmer pad 16 shown in FIG. 2. Such pads 16 are normally sold sealed in an outside plastic package and such pads usually contain some mixture of sodium chloride, water, activated carbon and iron powder. These reactants, depending on the particular composition, are normally activated either by repeatedly squeezing the pad 16 by hand or by shaking the pad for a few minutes, whereby the reactants are activated to produce a flow of heat from the pad. These hand warmers are commercially available under a variety of trademarks such as HOT HANDS® by HEATMAX® and SPORTS HEAT™ from many hunting or sports supply stores, such as Wal Mart, Kmart or Outdoor America.

Pursuant to the present invention, a scent producing composition, indicated as a scent source 18 in FIG. 2, is applied to the exterior of the pad 16, normally after the reactants in the pad 16 are activated to produce a flow of heat from the pad. Scent sources 18 are readily available from many different hunting supply stores, as mentioned above. A great variety of scents are available, depending upon the species of wild game being hunted.

After the pad 16 has become heated and the desired scent applied thereto, the pad 16 is placed in a pouch 20 as illustrated in FIG. 3. Typically the top 22 of the pouch 20 is open and may be sealed closed by any suitable mechanism such as a zip lock 24, velcro, or the like. Or the open end 22 may be suitably tied. Also, the pouch 20 is preferably provided with an aperture 26 there through by means of which the pouch 20 can be tied by a rope or string 12 from a tree limb 14 as shown in FIG. 1. The pouch 20 is formed of a material through which the scent vapor emanating from the pad 16 may penetrate into the surrounding atmosphere. For example, the pouch 20 may be formed of any suitable fabric, such as cotton, or may be a more solid material which is perforated by means of which the scent vapors can penetrate into the surrounding atmosphere.

Dispenser 10 may be utilized in any desired manner by the hunter, depending upon where the hunter believes the most effective location for the scent may be. For example, the pouch or the dispenser 10 may be simply placed on the ground near a hunting blind or may be suspended from a tree limb as shown in FIG. 1 at a location where the hunter believes the wild animal being sought would appear.

Changes may be made in the combination and arrangement of parts or elements or steps and procedures as heretofore set forth in the specification and shown in the drawings without departing from the spirt and scope of the invention as defined in the following claims:

What is claimed is:

1. A method of attracting wild animals comprising the steps of:
activating the reactants in a hand warmer pad to produce a flow of heat from the pad;
applying a scent composition to the heated pad;
placing the heated, scent producing hand warmer pad in a porous pouch through which the scent vapors may penetrate; and
placing the pouch in a location to attract the species of wild game desired.

2. The method of claim 1 wherein the reactants in the hand warmer pad are activated by repeated squeezing of the envelope.

3. The method of claim 1 wherein the reactants in the hand warmer pad are activated by shaking the pad for a few minutes.

4. The method of claim 1 further including the step of providing the pouch with a closure means and closing the pouch after the heated hand warmer pad is placed therein.

5. The method of claim 1 further including the step of suspending the pouch, with the heated hand warmer pad therein, from a tree limb or the like.

6. A wild animal scent lure dispenser comprising:
a pouch formed of a material through which a scent may penetrate;
a hand warmer pad in the pouch having the reactants therein activated, producing a flow of heat from the pad; and
a wild animal scent composition on the hand warmer pad;
whereby the wild animal scent penetrates the pouch and is dispensed in the area in which the pouch is placed.

7. The dispenser of claim 6 wherein the reactant in the hand warmer pad are reactants which are activated by repeated squeezing.

8. The dispenser of claim 6 wherein the reactants in the hand warmer are reactants which are activated by shaking for a few minutes.
